(19) United States
(12) Patent Application Publication
(10) Pub. No.: US 2019/0318695 A1
(43) Pub. Date: Oct. 17, 2019

(54) METHOD AND DEVICE FOR ELIMINATING IMAGE BORDER OF ELECTROPHORETIC ELECTRONIC PAPER

(71) Applicants: SOUTH CHINA NORMAL UNIVERSITY, Panyu District, Guangzhou, Guangdong (CN); SHENZHEN GUOHUA OPTOELECTRONICS CO., LTD., Longhua District, Shenzhen, Guangdong (CN); ACADEMY OF SHENZHEN GUOHUA OPTOELECTRONICS, Longhua District, Shenzhen, Guangdong (CN)

(72) Inventors: Guofu ZHOU, Shenzhen, Guangdong (CN); Li WANG, Shenzhen, Guangdong (CN); Pengfei BAI, Guangzhou, Guangdong (CN); Zichuan YI, Shenzhen, Guangdong (CN)

(73) Assignees: SOUTH CHINA NORMAL UNIVERSITY, Panyu District, Guangzhou, Guangdong (CN); SHENZHEN GUOHUA OPTOELECTRONICS CO., LTD., Longhua District, Shenzhen, Guangdong (CN); ACADEMY OF SHENZHEN GUOHUA OPTOELECTRONICS, Panyu District, Guangzhou, Guangdong (CN)

(21) Appl. No.: 16/469,892

(22) PCT Filed: Nov. 8, 2017
(86) PCT No.: PCT/CN2017/109838

§ 371 Date: Jun. 14, 2019

(30) Foreign Application Priority Data
Dec. 29, 2016 (CN) 201611249347.5

(51) Int. Cl. G09G 3/34; G09G 3/20

(52) U.S. Cl. CPC G09G 3/344; G09G 2320/0257; G09G 2310/06; G09G 3/2007

(57) ABSTRACT

A device and method for eliminating an image border of electrophoretic electronic paper includes the following steps: S1, acquiring gray-scale driving waveform information and gray-scale position information, wherein the driving waveform information comprises a level value and a duration corresponding thereof; S2, outputting regulation waveform information based on an termination level value of a first gray scale, a level duration and a starting level value of a second gray scale, wherein the regulation waveform information comprises a level value, an embedding time and an embedding position of a waveform; and S3, modifying the gray-scale driving waveform information based on the regulation waveform information, and controlling an output of a drive electrode based on the modified gray-scale driving waveform information. By using the device and method, an impact of the fringe electric field on movement of electronic paper micro-capsules is eliminated, thus effectively reducing border ghosting.

### CROSS-REFERENCE TO RELATED APPLICATIONS

This application is a national phase application of International Application No. PCT/CN2017/109838, filed Nov. 8, 2017, which claims priority to CN 201611249347.5, filed Dec. 29, 2016, all of which are hereby incorporated herein by reference.

### FIELD

The present disclosure relates to a method and a device for eliminating an image border of electrophoretic electronic paper, and belongs to the field of electrophoretic display.

### BACKGROUND

At present, the display technology of electrophoretic electronic paper is becoming mature, and the application scenarios of electrophoretic electronic paper is becoming more and more common, such as electronic label, billboard, electronic schoolbag, electronic watch, electronic reader, flexible display device, and the like. The electrophoretic electronic paper has a series of advantages, such as good bi-stable display characteristic, low power consumption, reflective paper-like display, easy realization of flexible display, etc., and the paper-like display characteristic is very popular with users, which makes it the first choice for long-time reading.

However, the driving waveform of the electrophoretic electronic paper still needs further optimization to improve a response speed and an image display quality of an electronic book, so that readers can achieve healthier and more comfortable reading experience.

EPD display refers to applying a voltage to upper and lower electrode plates of a TFT to drive black and white particles in a micro-capsule, so as to display an image. In a driving process of the electrophoretic electronic paper, each parallel-plate capacitor corresponds to a single pixel. Charges of the parallel-plate capacitor on the electrode plates are distributed unevenly, which makes fringes of adjacent plane-parallel capacitors interfere with each other during charging and discharging, thus forming a fringe electric field. The property of the fringe electric field needs to be distinguished according to the charges carried by the upper and lower electrode plates of two plane-parallel capacitors. The fringe electric field of the parallel-plate capacitor is to be ignored easily in traditional driving waveform design, which brings a series of problems in continuously refreshed image display. The charges are mainly distributed at the fringe and the sharp corner of a metal plate, the amount of charges at the fringe is larger than the amount of charges at the center, and amount of charges at the sharp corner is larger than the amount of charges at the fringe, which complies with the basic principle of tip discharge. Since the charges are distributed at the fringe and the sharp corner, a strong fringe field exists at the fringe, which may cause electric leakage or affect other devices around, which should be avoided be avoided as much as possible.

When an image is refreshed by an electrophoretic display, a ghosting of the previous image left easily. When a gray-scale area is refreshed, a border ghosting of the previous image will be remained.

### SUMMARY

In order to solve the problems above, the present disclosure provides a method for eliminating an image border of electrophoretic electronic paper, which comprises the following steps: S1, acquiring gray-scale driving waveform information and gray-scale position information, wherein the driving waveform information comprises a level value and a duration corresponding thereof; S2, output regulation waveform information based on the termination level values, level durations and predetermined threshold of the first and second gray scales, wherein the regulation waveform information comprises a level value, an embedding time and an embedding position of a waveform; and S3, modifying the gray-scale driving waveform information based on the regulation waveform information, and controlling an output of a drive electrode based on the modified gray-scale driving waveform information.

In one implementation, the step S2 comprises: calculating the difference between the termination level values of the first and second gray scales, acquiring durations of the respective termination levels, judging the difference and the level durations based on the predetermined threshold values, and outputting the regulation waveform information based on the judgment result.

In one implementation, the step S3 further comprises: storing the modified gray-scale driving waveform, and gray-scale driving waveforms of the first gray scale and the second gray scale, and marking the gray-scale driving waveforms as improved driving waveforms.

In one implementation, the level values of the driving waveforms are ±15 V and 0 V.

An aspect of the technical solution employed by the present disclosure is a device for eliminating an image border of electrophoretic electronic paper, which comprises an information acquisition module configured to acquire gray-scale driving waveform information and gray-scale position information, wherein the driving waveform information comprises a level value and a duration corresponding thereof; a modification output module configured to output regulation waveform information based on termination level values, level durations and predetermined threshold values of first and second gray scales, wherein the regulation waveform information comprises a level value, an embedding time and an embedding position of a waveform; and a drive module configured to modify the gray-scale driving waveform information based on the regulation waveform information, and control the output of a drive electrode based on the modified gray-scale driving waveform information.

In one implementation, the step S2 comprises calculating a difference between the termination level values of the first and second gray scales, acquiring durations of the respective termination levels, judging the difference and the level durations based on the predetermined threshold values, and outputting the adjustment waveform information based on the judgment result.

In one implementation, the step S3 further comprises storing the modified gray-scale driving waveform, and gray-scale driving waveforms of the first gray scale and the second gray scale, and marking the gray-scale driving waveforms as improved driving waveforms.

In one implementation, the level values of the driving waveforms are ±15 V and 0 V.

The beneficial effects of the present disclosure is by embedding an elimination waveform in driving waveforms of two transformation gray scales that are greatly affected by a fringe electric field, to eliminate the influence of fringe electric field on the movement of electronic paper microcapsules by means of staggered voltage regulation and synchronous voltage step-up, driving waveform thus effectively reducing border ghosting.

### BRIEF DESCRIPTION OF THE DRAWINGS

FIG. 1 is a schematic diagram of a method for eliminating an image border of electrophoretic electronic paper according to an embodiment of the present disclosure;

FIG. 2 is a waveform diagram of a gray scale generating the image border according to an embodiment of the present disclosure; and

FIG. 3 is a waveform diagram that the border is completely eliminated according to an embodiment of the present disclosure.

### DETAILED DESCRIPTION OF THE EMBODIMENTS

The present disclosure is described below with reference to the embodiments.

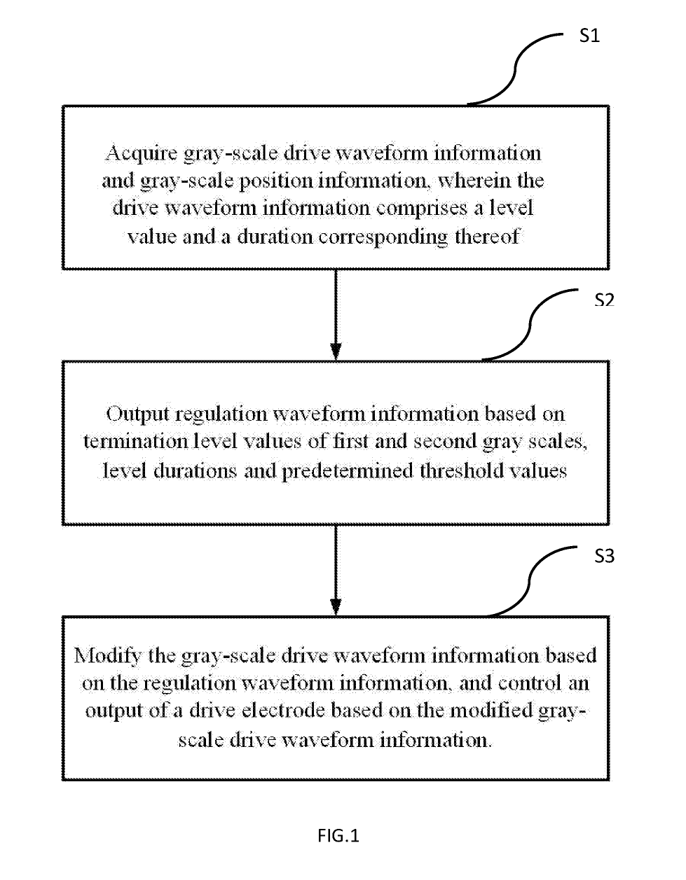

According to an embodiment of the present disclosure, FIG. 1 shows a method for eliminating an image border of electrophoretic electronic paper, which comprises the following steps: S1, acquiring gray-scale driving waveform information and gray-scale position information, wherein the driving waveform information comprises a level value and a duration corresponding thereof; S2, output regulation waveform information based on the termination level values, level durations and predetermined threshold of the first and second gray scales, wherein the regulation waveform information comprises a level value, an embedding time and an embedding position of a waveform; and S3, modifying the gray-scale driving waveform information based on the regulation waveform information, and controlling an output of a drive electrode based on the modified gray-scale driving waveform information.

Firstly, gray-scale transformation information is acquired, that is, gray-scale information of an image displayed on electronic paper is acquired, and the gray-scale information is used for outputting a target gray scale on the electronic paper at a corresponding position. The gray-scale driving waveform can comprise multiple transformed level values and corresponding durations thereof, while the driving waveforms of two adjacent gray scales will present a large voltage difference at a junction. However, not all the cases with a large (voltage) difference will cause ghosting, therefore, through a relationship between the voltage difference acquired through previous experimental tests and the level duration of the previous gray scale (the first gray scale) as well as the ghosting (i.e., the threshold value, wherein the threshold value is used to judge the conditions where the ghosting will occur), the regulation waveform information is outputted after judging through the acquired gray-scale information, which is used to be embedded into the driving waveforms of two gray scales at a position where the ghosting occurs, so as to play a buffering role. Meanwhile, in the whole process of the electronic paper, since a drive time thereof is predetermined, a balance between a ghosting area and a normal area shall be considered. Even if the regulation waveform is embedded only for a short time, synchronization of the gray scales at other positions will also be affected. Therefore, a short time can be embedded at other normal positions at the same time, i.e., when the regulation waveform occurs, for example, the level at position A is 15 V, on the basis of this time, time for regulation waveform is embedded to increase the duration of the waveform (the level) at position A to realize the overall balance. The regulation waveform is embedded between the driving waveforms of two gray scales, and the drive electrode is controlled to output the voltage to realize the change of gray-scale.

The step S2 comprises: calculating a difference between the termination level values of the first and second gray scales, acquiring durations of the respective termination levels, judging the difference and the level durations based on the predetermined threshold values, and outputting the regulation waveform information based on the judgment result.

Different levels and different durations will have different movement effects on the black and white particles in the micro-capsules, which is the reason causing the ghosting. By calculating the level difference and the durations of the termination levels of the first gray scale and the second gray scale, the threshold values are compared according to the experimental results and a selective value is outputted after the comparison with threshold value generated by experiments, the regulation waveform is loaded and outputted through the selection value (combining the waveform and the position where the waveform embeds, i.e., the regulation waveform information).

The step S3 further comprises: storing the modified gray-scale driving waveform, and gray-scale driving waveforms of the first gray scale and the second gray scale, and marking the gray-scale driving waveforms as improved driving waveforms.

For the purpose of improving the driving waveform, the modified gray-scale driving waveform is recorded; meanwhile, original data of two relevant gray scales (i.e., the first gray scale and the second gray scale that will generate the ghosting) are stored for subsequent analysis.

The level values of the driving waveforms are ±15 V and 0 V.

According to an embodiment of the present disclosure, a device for eliminating an image border of electrophoretic electronic paper comprises an information acquisition module configured to acquire gray-scale driving waveform information and gray-scale position information, wherein the driving waveform information comprises a level value and a duration corresponding thereof; a modification output module configured to output regulation waveform information based on termination level values, level durations and predetermined threshold values of first and second gray scales, wherein the regulation waveform information comprises a level value, an embedding time and an embedding position of a waveform; and a drive module configured to modify the gray-scale driving waveform information based on the regulation waveform information, and control the output of a drive electrode based on the modified gray-scale driving waveform information.

The step S2 comprises: calculating a difference between the termination level values of the first and second gray scales, acquiring durations of the respective termination levels, judging the difference and the level durations based on the predetermined threshold values, and outputting the regulation waveform information based on the judgment result.

The step S3 further comprises: storing the modified gray-scale driving waveform, and gray-scale driving waveforms of the first gray scale and the second gray scale, and marking the gray-scale driving waveforms as improved driving waveforms.

The level values of the driving waveforms are ±15 V and 0 V.

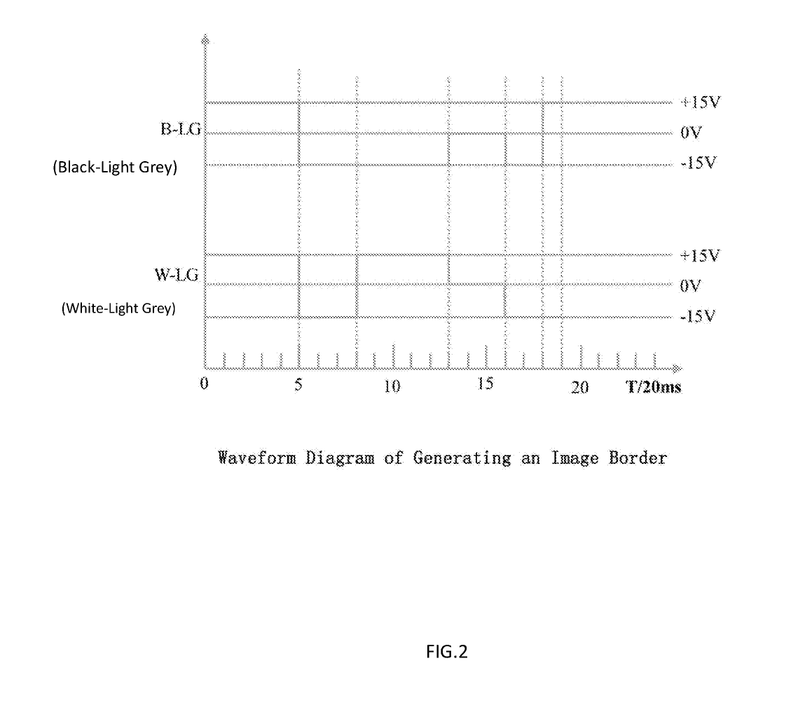

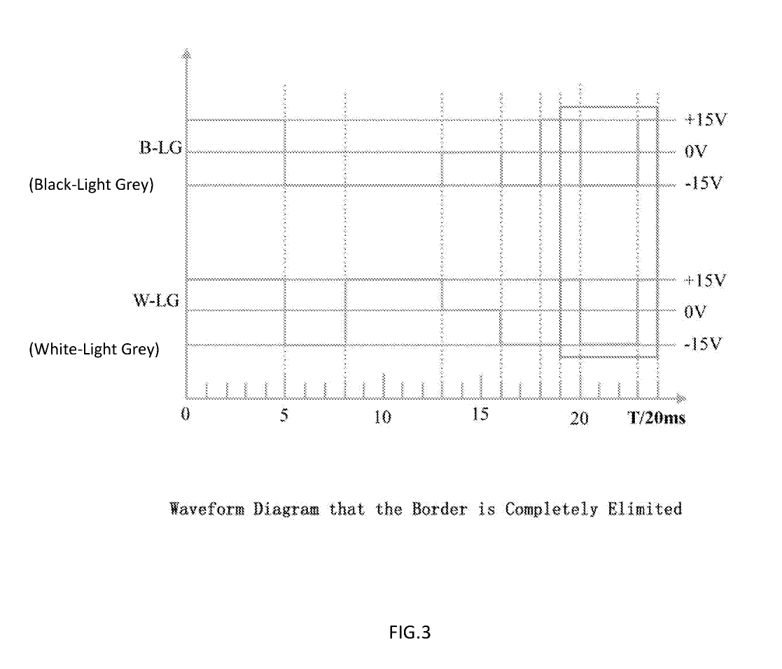

According to the embodiments of the present disclosure, FIG. 2 shows a waveform of the gray scale generating the image border, which has a large difference in level values at the termination level, thus causing the ghosting. FIG. 3 shows a waveform diagram that the border is completely eliminated, by staggered pressurization (i.e., high-voltage step-down and low-voltage step-up) and synchronous pressurization (with consistent time sequences), a contrast between high voltages and low voltages of two waveforms of adjacent different gray scales is avoided, and generation of reverse electric field is strictly avoided; and by activating particles, an acting time of an unilateral electric field is shortened, and the particles affected by the unilateral electric field are restored to normal in an eliminating stage.

The above mentioned is only preferred embodiments of the present disclosure, the present disclosure is not limited to the embodiments above, and only if the technical effect is reached by the same means, it shall fall in the protection scope of the present disclosure. In the protection scope of the present disclosure, the technical solutions and/or the embodiments can have various modifications and changes.

1. A method for eliminating an image border of electrophoretic electronic paper, comprising the following steps: S1, acquiring gray-scale driving waveform information and gray-scale position information, wherein the driving waveform information comprises a level value and a duration corresponding thereof; S2, outputting regulation waveform information based on termination level values, level durations and predetermined threshold values of the first and second gray scales, wherein the regulation waveform information comprises a level value, an embedding time and an embedding position of a waveform; and S3, modifying the gray-scale driving waveform information based on the regulation waveform information, and controlling an output of a drive electrode based on the modified gray-scale driving waveform information.

2. The method for eliminating an image border of electrophoretic electronic paper according to claim 1, wherein the step S2 comprises: calculating the difference between the termination level values of the first and second gray scales, acquiring durations of the respective termination levels, judging the difference and the level durations based on the predetermined threshold values, and outputting the regulation waveform information based on the judgment result.

3. The method for eliminating an image border of electrophoretic electronic paper according to claim 1, wherein the step S3 further comprises: storing the modified gray-scale driving waveform, and gray-scale driving waveforms of the first gray scale and the second gray scale, and marking the gray-scale driving waveforms as improved driving waveforms.

4. The method for eliminating an image border of electrophoretic electronic paper according to claim 1, wherein the level values of the driving waveforms are ±15 V and 0 V.

5. A device for eliminating an image border of electrophoretic electronic paper, comprising: an information acquisition module configured to acquire gray-scale driving waveform information and gray-scale position information, wherein the driving waveform information comprises a level value and a duration corresponding thereof; a modification output module configured to output regulation waveform information based on termination level values, level durations and predetermined threshold values of the first and second gray scales, wherein the regulation waveform information comprises a level value, an embedding time and an embedding position of a waveform; and a drive module configured to modify the gray-scale driving waveform information based on the regulation waveform information, and control an output of a drive electrode based on the modified gray-scale driving waveform information.

6. The device for eliminating an image border of electrophoretic electronic paper according to claim 5, wherein the step S2 comprises: calculating the difference between the termination level values of the first and second gray scales, acquiring durations of the respective termination levels, judging the difference and the level durations based on the predetermined threshold values, and outputting the regulation waveform information based on the judgment result.

7. The device for eliminating an image border of electrophoretic electronic paper according to claim 5, wherein the step S3 further comprises storing the modified gray-scale driving waveform, and gray-scale driving waveforms of the first gray scale and the second gray scale, and marking the gray-scale driving waveforms as improved driving waveforms.

8. The device for eliminating an image border of electrophoretic electronic paper according to claim 5, wherein the level values of the driving waveforms are ±15 V and 0 V.
